(19) United States
(12) Patent Application Publication
(10) Pub. No.: US 2007/0125048 A1
(43) Pub. Date: Jun. 7, 2007

(54) Natural gas filter for particulate and liquid impurities

(75) Inventors: Gary Hunsinger, Rochester, NY (US); Matthew Geier, Webster, NY (US)

Correspondence Address: HISCOCK & BARCLAY, LLP, 2000 HSBC PLAZA, 100 Chestnut Street, ROCHESTER, NY, 14604-2404, US

(73) Assignee: Shawndra Products

(21) Appl. No.: 11/299,261

(22) Filed: Dec. 7, 2005

(51) Int. Cl. B01D 50/00

(52) U.S. Cl. 55/319; 55/482

(57) ABSTRACT

A filtration apparatus for separating particulate and liquid impurities, such as dust, liquid or oil, from a natural gas. The filtration apparatus has a horizontally oriented enclosure with a plurality of filter elements which are not in parallel with the long axis of the enclosure, thus enabling filtered particles to fall out of the filter elements into a collection sump for later removal. To facilitate filtrate collection, the dividing plate, upon which the filter elements are mounted, is angled slightly out of level for the purpose of guiding the filtered particulate and liquid impurities to a collection sump. The inlet and outlet nozzles are located at the ends of the enclosure and are in line with its long axis. Through these nozzles, the gas flowing into the enclosure undergoes a rapid expansion, which serves to remove larger particles and liquids entrained in the gas. The gas is further “pre-filtered” by forcing it through a tortuous path of abrupt changes in direction prior to encountering the filter elements. This removal of coarse particles and liquids serves to lengthen filter element life and reduce maintenance time. To further reduce maintenance time, the enclosure contains a plurality of accesses whereby a person may open this access and remove a corresponding filter element with minimal impact on filtration apparatus operability.

### FIELD OF THE INVENTION

This invention relates to filters and filter/separators used, for example, in the removal of liquids and/or solids from a stream of natural gas.

### BACKGROUND OF THE INVENTION

When it is originally mined, natural gas exists in a “dirty” state with entrained liquids, particulates and other impurities, which must be removed before shipping the gas to distribution hubs via a pipeline network. Filter apparatus designs are plentiful in this area, however, none of the designs for the filtration of particulates or liquids effectively addresses the issues of maximizing filter effectiveness and reducing filter maintenance while, at the same time, maintaining a configuration that allows for easy access and minimal visual impact.

For example, many filtration systems disclosed in prior art are vertical in nature. This is to say that the long axis of the apparatus is substantially vertical, with the filter inlet located at the top and the outlet located at the bottom or vice-versa. As is able to be seen in schematics or photographs of such a design, a vertically mounted filtration apparatus has an unusually large physical profile. With such designs, an apparatus must be either at least partially underground or be accompanied with a ladder for a worker to reach the full height. However, a vertically oriented filter underground would be substantially inaccessible for maintenance and, if placed above ground, the replacement of some filter elements installed within a vertically oriented enclosure may be a significant distance off the ground, increasing the possibility of injury to the workers. Consequently, a filtration apparatus with a horizontal orientation is desired in the art.

Additionally, most filtration systems contain filter elements oriented in a substantially horizontal direction although, in many of these designs, this cannot be helped as the horizontal arrangement of the filter elements is dictated by the orientation of the enclosure containing these elements. Horizontal elements, however, are generally deficient for two reasons. First, particles that are filtered out will settle in the filter material causing a gradual buildup of particulates. Such buildup leads to potential clogging, increased need for filter replacement and potential filter failure. Second, horizontally aligned filter elements are difficult to access and repair. Typically, these filters must be removed out of the side of the filtration apparatus enclosure, or else the enclosure itself must be completely disassembled. Both issues can present significant time requirements for filter replacement and increase down-time of the filter's operability. Therefore, a filtration apparatus with vertical filter elements is desired in the art.

Also, filter life may be enhanced through the use of “pre-filtering” or removal of larger particulates prior to the gas interacting with the filter. Many designs do not contemplate the concept that the life of a filter element will be lengthened, and need for maintenance thereby reduced, when the level of particulates is reduced in the gas prior to the filter elements. Thus, a filtration apparatus with a pre-filtering capability is desired in the art.

While some designs in the prior art contemplate some aspects of the present invention, none recognize the need for these aspects in a single design. For example, U.S. Pat. No. 4,298,474 to Sillers discloses a “multiple filter vessel”, which comprises a plurality of filters in a generally horizontal enclosure. However, the filters are in a horizontal orientation and it is impossible to repair or replace these filters without disassembling the entire enclosure. Therefore, maintenance of the filter elements in this design may be difficult and inefficient.

U.S. Pat. No. 3,375,058 to Peterson et al. discloses an “apparatus and method for separating suspended substances from gas currents”. This invention involves the expansion and abrupt change in gas flow for the removal of particles through the use of slits and nozzles. However, these units are horizontally mounted leading to the potential buildup of particulates and clogging of the elements. Furthermore, this invention does not disclose the use of a mesh filter or some other conventional filter element commonly seen in other related art.

U.S. Pat. No. 4,666,473 to Gerdau discloses a “separator for gases and liquids”. This invention discloses a filter with a vertical filter element and also utilizes an angled flow path to allow for coarse particulate removal. However, this design does not allow for the use of multiple filter elements, which would spread out filter wear and thereby reduce maintenance requirements. Also, this design is generally vertical in nature and does not solve the problems of tall profile or pipe flow restriction inherent in vertical filtration apparatus design.

U.S. Pat. No. 5,919,284 to Petty et al. discloses a “gas filter coalescer and multi-stage vessel”. This invention discloses a horizontally oriented enclosure, however, the filter elements are also of a horizontal orientation which may lead to particulate buildup within the filter element resulting in shorter filter element life and increased maintenance requirements. Furthermore, access to the filter elements is limited and replacement may be difficult. This may result in increased maintenance time and subsequent down time of the filtration apparatus as a whole.

### SUMMARY OF THE INVENTION

The present invention is a filtration apparatus for natural gas with the ability to remove particulates, entrained liquid, or a combination of the two. The invention comprises a horizontally oriented enclosure, preferably of cylindrical shape, with a closure head on each end. Connected at each closure head is either an inlet or outlet nozzle through which the gas enters or exits the enclosure. Within the enclosure is a dividing plate that functions primarily for preventing gas from by-passing the filter elements as well as providing a structural foundation for mounting a plurality of filter elements. For every individual filter element installed in the enclosure, an access is provided for easy repair, removal and replacement of used filters without the total disassembly of the filtration apparatus. In addition, this invention contains a number of aspects which make it much more effective than other designs.

First, the enclosure is in a horizontal arrangement, thereby avoiding many of the deficiencies intrinsic to a vertically mounted filtration apparatus. The profile is much lower and non-obtrusive than a vertically mounted apparatus and, in fact, the filtration apparatus can be installed partially or completely underground and still be easily accessible. Furthermore, a horizontal arrangement runs in the same direction as the piping thereby simplifying installation and streamlining pipeline flow path

Second, the horizontal arrangement of the enclosure allows for a plurality of filter elements to be vertically installed, side by side, within the enclosure. This design allows unfiltered gas to enter vertically upward into the filter element chamber, wherein the particles which are filtered out are much less likely to stay in the filter element chamber, but instead will fall out of the filter into a collection sump where it can be periodically removed. Because of this design, filter elements last longer, perform more efficiently and are less likely to fail than filter elements that are horizontally mounted in the enclosure.

A third advantage of this invention is its ability to channel flow of filtered particulates and liquids to collection sumps and disposal. In the preferred embodiment, where the filter elements are upright, the dividing plate is slightly (1-3°) off level both along the long and short axis of the enclosure. This “tilting” of the dividing plate allows for the channeling of any removed liquid to a collection sump where it can be drained.

Another advantage to the present invention is the location of the dividing plate and the role it serves in pre-filtering a gas. Experimental use has shown that the dividing plate baffles, which fasten the dividing plate to the enclosure wall, interfere with the gas flow as it enters the enclosure from the inlet nozzle and force the gas to be suddenly redirected as it proceeds through the enclosure. These abrupt redirections, which create a tortuous flow path for the gas resulting in more turbulent gas flow, result in a large amount of particulate removal before the gas encounters the filter elements. This removal of particulates through the turbulent redirection of gas significantly enhances filter element life and reduces the need for filter element maintenance.

The prefiltering characteristics of this invention are also enabled by the enclosure design. In the most preferred embodiment, the cross sectional area of the flow path dramatically increases as the gas leaves the inlet nozzle and enters the enclosure itself. This large change in cross sectional area results in a similar rapid increase in gas volume. This sudden expansion aids in the removal of particulate and liquid matter from the gas prior to it reaching the filter elements. This attribute also significantly enhances filter element life and reduces the need for filter element maintenance.

### BRIEF DESCRIPTION OF THE DRAWINGS

The above-mentioned and other features and advantages of this invention, and the manner of attaining them, will become apparent and be better understood by reference to the following description of one embodiment of the invention in conjunction with the accompanying drawings, wherein:

FIG. 1 is a side view of the filtration apparatus as disclosed in the present invention.

FIG. 2 is a cross sectional view of the filtration apparatus as disclosed in the present invention.

FIG. 3 is a close view of the cylindrical view of the filter element used in the most preferred embodiment of the present invention.

FIG. 4 is a close view of the filter element fastener.

FIG. 5 is a close view of the filter element and filter element fastener as applied in the present invention.

Corresponding reference characters indicate corresponding parts throughout the several views. The examples set out herein illustrate one embodiment of the invention but should not be construed as limiting the scope of the invention in any manner.

### DETAILED DESCRIPTION

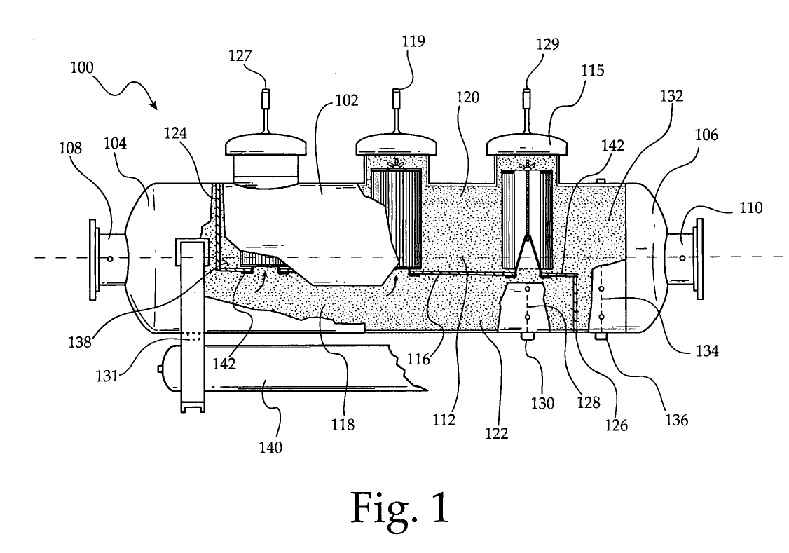

The current invention discloses a filtration apparatus for all types of natural gases and specifically, in the most preferred embodiment, coal bed methane (CBM). As may be viewed in FIG. 1, the filtration apparatus 100 consists primarily of an enclosure 102, with a closure head 104, 106 on each end. Attached to each closure head is an orifice nozzle for the flow of CBM in or out of the filtration apparatus 100. The inlet nozzle 108, is attached to the inlet closure head 104 and, similarly, the outlet nozzle 110, is attached to the outlet closure head 106. The inlet nozzle 108 or outlet nozzle 110 may be attached at any location on its respective closure head 104, 106 and may even be attached directly on the body of the enclosure 102 itself. In the preferred embodiment, the inlet nozzle 108 and outlet nozzle 110 are attached substantially to the center of their respective closure heads 104, 110 as this allows a relatively continuous alignment along the long axis 112 of the filtration apparatus. The enclosure 102 and associated closure heads 104, 106 may be a number of shapes including square or rectangular prism, but the most preferred shape is cylindrical.

Within the enclosure 102 are a plurality of filter elements 114 arranged in parallel to allow simultaneous filtration through all the elements. In the preferred embodiment the filter elements 114 are cylindrical in shape and are mounted, at one end, to a dividing plate 116 which separates the enclosure 102 into an inlet side 118 and an outlet side 120. As one can see from FIG. 1, the dividing plate 116 prevents the flow of CBM gas from the inlet 108 to the outlet 110 without traveling first through one of any number of filter elements 114.

Because of the horizontal alignment of the enclosure 102, the filter elements 114 may be aligned in an orientation out of parallel with the long axis 112 of the enclosure in a side-by-side arrangement. As shown in FIG. 1, the preferred orientation of the filter elements 114 is substantially perpendicular, although this will depend upon the shape of the filter element. This alignment is beneficial over a horizontal alignment commonly found in prior art because it allows particulates that are filtered out to fall, aided by gravity, out of a filter element 114 and into a collection sump 122 at the bottom of the enclosure. Such a design dramatically increases filter efficiency, reduces the risk of filter failure and lowers the time in which the apparatus is inoperative due to maintenance. Also, since the gas to be filtered must travel up into the filter from below, this design is specifically useful for light gases as opposed to relatively heavy liquids.

The filter elements may be comprised of a number of materials and serve a number of functions. Such compositions include, but are not limited to, polyester, fiberglass, or some combination thereof. In general, and as shown in FIG. 3, a filter element is cylindrical in shape, but it does not have to be of this configuration. The actual filtering material 300 is placed in a zig-zag pattern, thereby maximizing the surface area for more effective filtration. Both the inlet side 302 and the outlet side 304 of the filter element are covered in a porous metal casing 306 for both structural support and offering a location for liquid drop formation if the filter element is to serve a coalescing function. In FIG. 3, the porous metal casing 306 is designed with a large number of small holes 308. The size of the holes 308 can be altered to change the metal casing's porosity. This may be especially important in cases where the filter element 114 will serve a coalescing function.

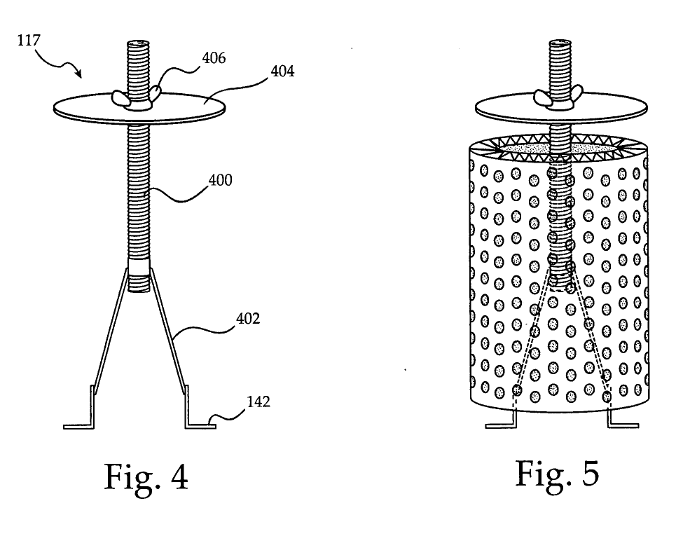

Due to the potentially high flow rate of the CBM gas, the filter elements 114 must be held in place by a fastener 117 which is shown in more detail in FIG. 4. In the preferred embodiment, the fastener comprises a threaded metal rod 400 which is attached at its bottom to a number of lower connecting rods 402. These connecting rods are attached to a baffle 142, which penetrates the dividing plate 116, as seen on FIG. 1 and also provides a physical seal between the dividing plate 116 and the filter element 114. To prevent the leaking of CBM gas out the upper end of the filter element, the fastener 117 also comprises a disc shaped cap 404, placed around the threaded rod 400 and will seal the top of the filter element 114. To secure the filter element and to minimize leak-by past the cap, a nut 406 is used to tighten the cap 404. Any fastening nut may be used, however, for the ease of maintenance, a butterfly nut is most effective. When a filter element is installed, it will be fastened as seen in FIG. 5.

For the ease of maintenance, each filter element 114 may be accessed through a quick opening closure 115. These closures may be screw-on, hinged or firmly attached by other means. The ability to remove and replace filter elements 114 out of the top of the enclosure 102 via the opening closures 115 should be apparent. Due to the generally horizontal arrangement of the filtration apparatus, it is possible that the filter could be almost entirely underground, wherein the only aspect above ground are the opening closures 115 for the periodic replacement or repair of the filter elements 114. Because of the contemplated arrangement where the bulk of the filtration apparatus is inaccessible (i.e. underground), the opening closures 115 are each accompanied by a pressure relief connection 119 to prevent an overpressure condition in the enclosure. In a situation where the filtration apparatus is accessible (i.e., not underground), pressure relief connections 127, 129 are supplied on the inlet side 118 and outlet side 120 of the enclosure 102. While it is not normally expected that the filtration apparatus will operate at high pressure, higher operating pressures are capable of being supported by the invention. In addition, the pressure relief connections protect the enclosure from structural damage in the case of an ignition of the CBM gas, which may result in an extremely high pressure pulse due to the rapid expansion of the ignited gas (known as “flash” pressure).

In the preferred embodiment, as shown in FIG. 1, the dividing plate 116, upon which the filter elements 114 are mounted, is substantially parallel to the long axis 112 of the enclosure 102. Unlike inventions disclosed in prior art, the dividing plate 116 does not extend straight across the enclosure, but instead is mounted in the enclosure 102 through the use of two baffle plates 124, 126. Although the baffle plates serve the purpose of structural stability of the dividing plate, the inlet side baffle 124, also serves a very useful purpose in the filtration process. As is shown in FIG. 1, gas that enters into the enclosure via the inlet nozzle 108 will impact the inlet side baffle 124 and be abruptly shifted downward and into the inlet side of the dividing plate 118. This tortuous flow path that the gas must travel causes a large amount of particulate and liquid separation before the gas encounters the filter elements 114. Experimental use has shown that this method of particulate/liquid removal creates vastly improved filtering performance as well as increased preservation of the filter elements, resulting in less filter element failure and reduced maintenance requirements. Particulate and liquid removal is also enhanced through the large volumetric change the CBM gas encounters when it leaves the inlet nozzle 108 and enters the much larger area comprising the inside of the inlet closure head 104 and the area of the enclosure 102 before the baffle plate 124.

Particulates and liquids that are removed through both expansion of the CBM gas and the tortuous flow path that the gas must undergo fall to the bottom of the enclosure, which also serves as an inlet side collection sump 122. As can be seen in FIG. 1 and as previously mentioned, this collection sump also collects particulates and liquids that are filtered out in the filter elements 114 and fall, gravity aided, out of the filter element. Inlet side collection sump level can be measured by a gauge glass 128, which is located on the side of the enclosure. When the inlet side collection sump 122 is full, the filtrate may be removed via the inlet side collection sump drain plug 130 installed at the bottom of the collection sump. Due to the length of the inlet side collection sump, a second drain 131 may be necessary. Also, for ease of use, the drain plug 130 is installed directly below the gauge glass 128, however, the drain plug can theoretically be installed anywhere within the collection sump.

On the occurrence that some particulate, liquid or mixture thereof is removed, but is extracted on the outlet side of the filter elements 114, an outlet side collection sump 132 may be necessary as well. Much like its counterpart on the inlet side of the dividing plate, the outlet side collection sump is also accompanied by a gauge glass 134 and a drain plug 136. In the preferred embodiment, the outlet side collection sump 132 is at the bottom of the enclosure 102 and bracketed by the outlet side baffle 126 and the outlet side closure head 106.

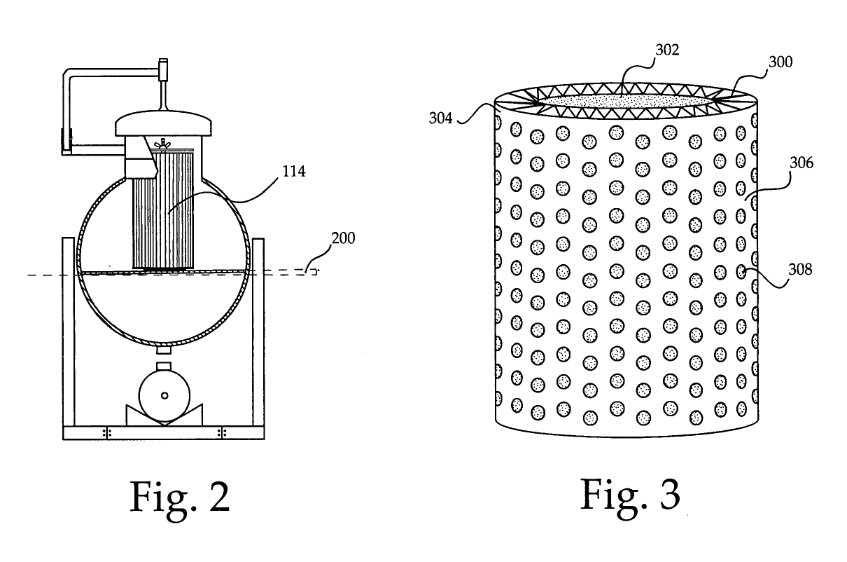

As a buildup of particulate/liquid filtrate on the outlet side of the filter could significantly impede filter element performance, the filtrate must be channeled to the outlet side collection sump 132. Therefore, in the preferred embodiment, the dividing plate 116 is at a small angle 138 (1°-3° in the preferred embodiment) from parallel with both the long axis of the enclosure and a similarly small angle 200 with the short axis of the enclosure, as shown in FIG. 2. These small angles enable the filter elements 114 to remain substantially perpendicular to the long axis of the enclosure, thereby preventing particulate buildup in the filter elements, while guiding filtered particles and liquids on the outlet side to the outlet side collection sump 132.

To protect the collection sumps from overflowing, a holding tank 140 may be installed under the drain plugs 130, 131 & 136 thus enabling the collection sumps to be periodically drained while, at the same time, preventing the particulate/liquid filtrate from being released into the environment.

While the invention has been described with reference to a particular embodiment, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention.

Therefore, it is intended that the invention not be limited to the particular embodiments disclosed as the best mode contemplated for carrying out this invention, but that the invention will include all embodiments falling within the scope and spirit of the appended claims.

What is claimed is:

1) A filtration apparatus for natural gas comprising:
a) a first horizontally oriented filter enclosure with at least one inlet nozzle and at least one outlet nozzle;
b) a second horizontally oriented filter enclosure with at least one inlet nozzle and at least one outlet nozzle;
c) a dividing plate between said inlet and said outlet in said first and second horizontal enclosures;
d) a plurality of filter elements attached to said dividing plates;
e) a plurality of access points for repair and replacement of said filter elements; and
f) at least one drain connecting port;
g) a dividing plate non-horizontally disposed between said horizontally oriented enclosures.

2) The filtration apparatus of claim 1, wherein said filter elements are in a non-parallel alignment with the long axis of said enclosure.

3) The filtration apparatus of claim 1, wherein said filter elements are substantially vertical.

4) The filtration apparatus of claim 1, wherein said dividing plate upon which said filter elements are attached is substantially parallel with the long and short axes of said enclosure.

5) The filtration apparatus of claim 1, wherein said non-horizontally disposed dividing plate guides the flow of liquid and particulate filtrate from the outlet side of said filter elements to a collection sump.

6) The filtration apparatus of claim 5, wherein said drain connecting port is attached to the bottom of said collection sump for the periodic collection of accumulated filtrate.

7) The filtration apparatus of claim 1, wherein said natural gas leaving said inlet enters a zone of relatively large volume enabling rapid expansion of said natural gas.

8) The filtration apparatus of claim 1, wherein said natural gas entering said enclosure proceeds through a tortuous flow path before reaching said filter elements.

9) The filtration apparatus of claim 1, wherein a collection tank is placed beneath the enclosure for the collection of filtered liquid and particulate.

10) The filtration apparatus of claim 1, wherein said filter elements filter solid particulates from said natural gas.

11) The filtration apparatus of claim 1, wherein said filter elements function as coalescers in the removal of entrained liquids.

12) The filtration apparatus of claim 1, wherein said filter elements are fastened to said dividing plate via a fastening means.
